(19) United States
(12) Patent Application Publication
(10) Pub. No.: US 2010/0044375 A1
(43) Pub. Date: Feb. 25, 2010

(54) SELF-SEALING DISPENSER CAP AND METHOD FOR ASSEMBLING THE SAME

(76) Inventor: Ross E. Rockstad, Maple Valley, WA (US)

Correspondence Address: JOHN S. BEULICK (24691);ARMSTRONG TEASDALE LLP, ONE METROPOLITAN SQUARE, SUITE 2600, ST. LOUIS, MO, 63102-2740, US

(21) Appl. No.: 12/196,588

(22) Filed: Aug. 22, 2008

(51) Int. Cl. B65D 51/16; B67D 5/06; B23P 19/04; F16K 1/14

(52) U.S. Cl. 220/203.29; 222/564; 251/315.01; 220/361; 29/700

(57) ABSTRACT

A cap assembly is provided that includes a cap comprising an inner surface and an outer surface, a tip extending from the outer surface of the cap, wherein the tip includes an aperture therethrough operable to dispense the fluid stored within the dispenser. The cap assembly also includes a stem extending inward from the inner surface of the cap, wherein the stem is axially aligned and coupled in flow communication with the aperture of the tip. The stem includes a release valve assembly positioned along a length of the stem, wherein the release valve assembly facilitates creating a sealed surface therein and substantially prevents the liquid from passing out of the dispenser. The cap assembly further includes a stabilizing valve assembly extending from the inner surface of the cap to the outer surface of the cap.

### BACKGROUND

The field of the disclosure relates generally to caps for fluid dispensers, and more specifically to self-sealing caps for chemical dispensers.

Some known fluid storage dispensers include a flexible body that may discharge a liquid contained therein through an opening in the dispenser when a squeezing pressure, for example from an operator's hand is applied. Some known dispensers may include a sealing means that provides a subsequent sealing action after the pressure is removed, but such dispensers require a two-handed arrangement with these dispensers wherein the closing action must be done by the operator's second hand. Some other known dispensers simply require that each hand manipulate one of two parts to facilitate closing the fluid dispenser.

A known housing for a control valve used on a squeeze type fluid dispensing container includes a first check valve fixedly coupled inside a housing. When the first check valve is opened, fluid flow is permitted through an opening and out of a tube in the housing. A second such check valve is fixedly coupled inside the first check valve, and when opened, facilitates channeling the fluid flow from the tube into the housing, then through an opening in the housing and back into the dispenser.

Some other known fluid dispensers provide a dual-valving system. Such dual valve assemblies respond to differences in pressure, and cooperate to dispense the fluid from the dispenser, or seal the openings thereof during non-use. The cap may include a valve positioned within the dispenser outlet which is cleaned of material at the end of the dispensing period by the action of the dispenser mechanism herein. However, such dual valve assemblies are not directly exposed to the atmosphere, and fail to allow ambient air into the dispenser to normalize the squeezable bottle, while maintaining the liquid, and any gaseous product associated with the liquid, within the dispenser during periods of non-use.

### SUMMARY

In one aspect, a dispenser for storing a fluid is provided. The dispenser includes a self-sealing dispenser cap assembly, and a flexible body portion that includes a mouth configured to receive the dispenser cap assembly thereon. The cap assembly includes a cap comprising an inner surface and an outer surface, a tip extending from the outer surface of the cap, wherein the tip includes an aperture therethrough operable to dispense the fluid stored within the dispenser. The cap assembly also includes a stem extending inward from the inner surface of the cap, wherein the stem is axially aligned and coupled in flow communication with the aperture of the tip. The stem includes a release valve assembly positioned along a length of the stem, wherein the release valve assembly facilitates creating a sealed surface therein and substantially prevents the liquid from passing out of the dispenser, and wherein applying a force to the dispenser facilitates channeling fluid through the release valve assembly. The cap assembly further includes a stabilizing valve assembly extending from the inner surface of the cap to the outer surface of the cap, wherein removing the force from the dispenser facilitates channeling a quantity of air through the stabilizing valve assembly and the said dispenser.

In another aspect, a self-sealing dispenser cap assembly is provided. The cap assembly includes a cap comprising an inner surface and an outer surface, a tip extending from the outer surface of the cap, wherein the tip includes an aperture therethrough operable to dispense the fluid stored within the dispenser. The cap assembly also includes a stem extending inward from the inner surface of the cap, wherein the stem is axially aligned and coupled in flow communication with the aperture of the tip. The stem includes a release valve assembly positioned along a length of the stem, wherein the release valve assembly facilitates creating a sealed surface therein and substantially prevents the liquid from passing out of the dispenser, and wherein applying a force to the dispenser facilitates channeling fluid through the release valve assembly. The cap assembly further includes a stabilizing valve assembly extending from the inner surface of the cap to the outer surface of the cap, wherein removing the force from the dispenser facilitates channeling a quantity of air through the stabilizing valve assembly and the said dispenser.

In yet another embodiment, a method for assembling a self-sealing dispenser cap is provided. The method includes providing a cap comprising an inner surface and an outer surface, extending a tip from the outer surface of the cap, the tip comprising an aperture therethrough operable to dispense a liquid stored within the dispenser, and extending a stem inward from the inner surface of the cap such that the stem is axially aligned and coupled in flow communication with the aperture of the tip. The method further includes positioning a release valve assembly at a point along a length of the stem, wherein the release valve assembly facilitates creating a sealed surface therein and substantially preventing the fluid from passing out of the dispenser, and extending a stabilizing valve assembly from the inner surface of the cap to the outer surface of the cap, wherein removing the force from the dispenser facilitates channeling a quantity of air through said stabilizing valve assembly and into said dispenser.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

FIG. 1 is schematic illustration of an exemplary dispenser used for storing a fluid therein.

FIG. 2 is a schematic illustration of an exemplary self-sealing cap assembly used with the dispenser shown in FIG. 1.

FIG. 3 is a schematic illustration of a valve used with the self sealing cap assembly shown in FIG. 2.

FIG. 4 is a flowchart of an exemplary method of assembling the self-sealing cap assembly shown in FIG. 2.

### DETAILED DESCRIPTION

The following detailed description illustrates the disclosure by way of example and not by way of limitation. The description should enable one skilled in the art to make and use the system described herein, describes several embodiments, adaptations, variations, alternatives, and uses of the disclosure, including what is presently believed to be the best mode of carrying out the disclosure. The disclosure is described as applied to exemplary embodiments, namely, a self-sealing cap for a fluid dispenser and methods of fabricating such caps. However, it is contemplated that this disclosure has general application to any fluid container in industrial, commercial, and residential applications.

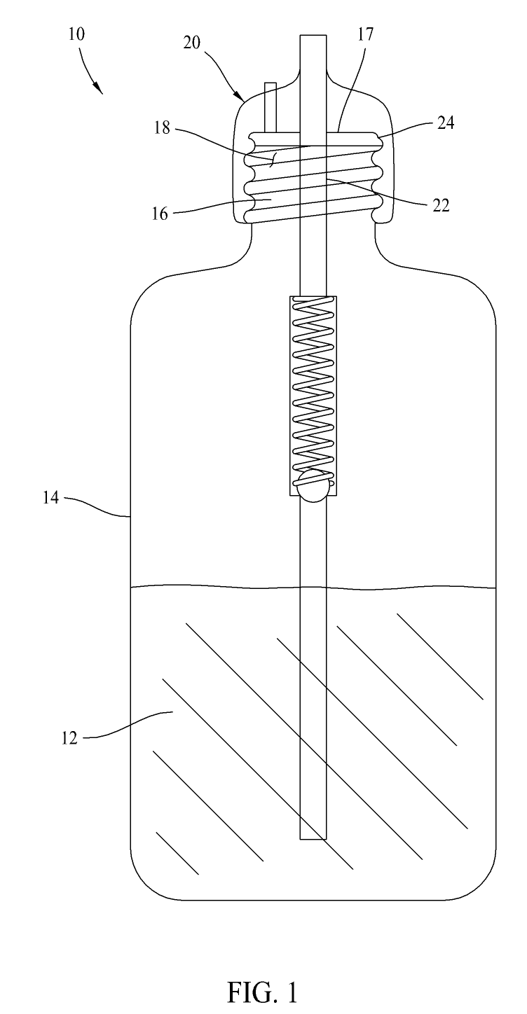

FIG. 1 is schematic illustration of an exemplary dispenser 10 used for storing an amount of fluid 12 therein. Dispenser 10 includes a body portion 14 for use in containing and storing fluid 12. In the exemplary embodiment, dispenser 10 is fabricated from a flexible material, such as, but not limited to a polymer or plastic. A mouth portion 16 extends from body portion 14 and includes an orifice 17 that is sized and oriented to enable fluid 12 to be introduced into dispenser 10. Mouth portion 16 includes an outer surface 18 configured to be coupled to a cap assembly 20. In the exemplary embodiment, outer surface 18 includes a plurality of threads 22 that are sized and oriented to threadably couple with a plurality of corresponding threads 24 disposed on cap assembly 20. Alternatively, cap assembly 20 may be coupled to mouth portion 16 over outer surface 18 using any coupling method such as, but not limited to, friction fitting, a tab and groove combination, and/or with any coupling configuration that enables dispenser 10 to function as described herein.

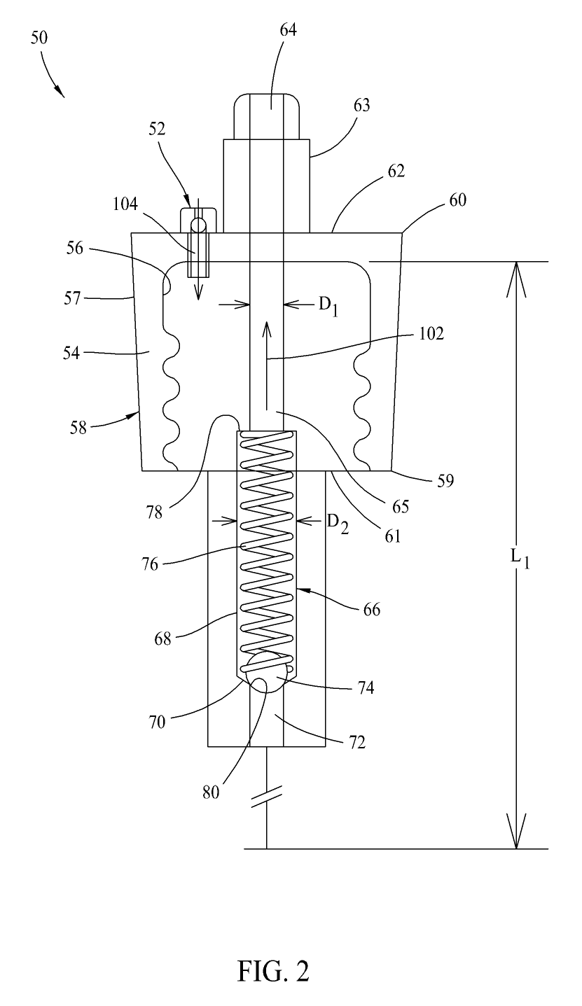

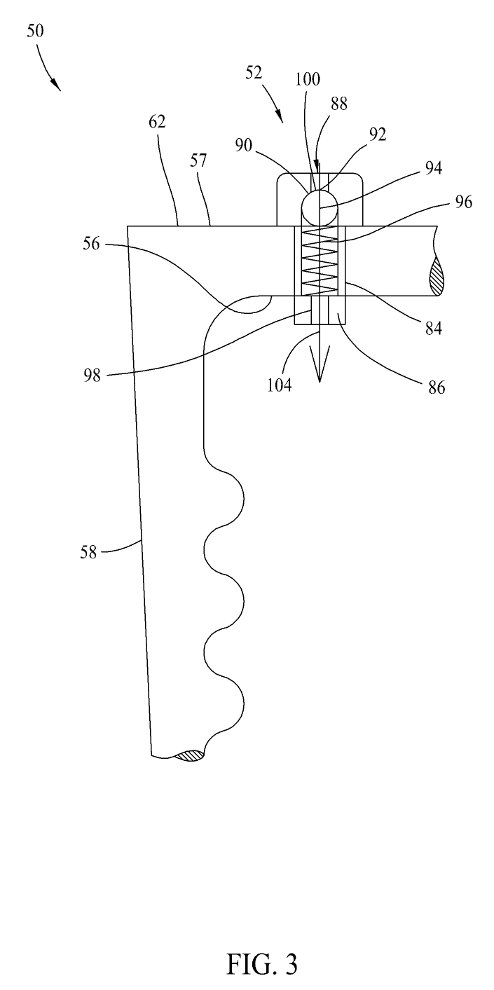

FIG. 2 is a schematic illustration of an exemplary self-sealing cap assembly 50 that may be used with the dispenser 10 shown in FIG. 1. FIG. 3 is a schematic illustration of a stabilizing valve assembly 52 used with the self sealing cap assembly 50 shown in FIG. 2. In the exemplary embodiment, cap assembly 50 includes a cap 54 having an inner surface 56 and an outer surface 57. Cap 54 includes a substantially cylindrical coupling portion 58 that includes a first end 59 and a second end 60. First end 59 of cap 54 includes an opening 61 that is sized and oriented to receive mouth portion 16 (shown in FIG. 1) therein. Cap 54 includes a substantially flat top portion 62 that extends across second end 60 of cap 54. In the exemplary embodiment, cap assembly 50 includes a tip 63 extending from outer surface 57 of top portion 62 of cap 54, and includes an aperture 64 therethrough operable to dispense fluid 12 stored within dispenser 10 (shown in FIG. 1). Alternatively, cap 54 may not include tip 63, but may simply include an aperture (not shown) therethrough that is sized and oriented to enable dispensing fluid 12 from dispenser 10 as described in more detail herein.

In the exemplary embodiment, cap assembly 50 includes a stem 65 extending inward from inner surface 56 of top portion 62 of cap 54. Stem 65 is axially aligned and coupled in flow communication with aperture 64 of tip 63, and stem 65 includes a first diameter D₁. In the exemplary embodiment, stem 65 includes a release valve assembly 66 disposed along a length L₁ of stem 65 and positioned adjacent to cap 54. Alternatively, release valve assembly 66 may be disposed at any position along length L₁. More specifically, release valve assembly 66 includes a tube 68 therein having a second diameter D₂, wherein diameter D₂ is larger than diameter D₁. In the exemplary embodiment, a semi-spherical valve seat 70 is disposed at a lower end 72 of tube 68. A ball stop 74 is positioned against valve seat 70 and biased against valve seat 70 via a spring 76 that extends from an upper end 78 of tube 68 to ball stop 74. In the exemplary embodiment, ball stop 74 is sized and oriented to create a sealed surface 80 defined between ball stop 74 and valve seat 70 such that no fluid 12 may flow therethrough when ball stop 74 is biased against valve seat 70.

In the exemplary embodiment, and now referring to FIG. 3, cap assembly 50 includes a stabilizing valve assembly 52 that extends from inner surface 56 of top portion 62 of cap 54 to outer surface 57 of cap 54 within a channel 84 and is positioned adjacent to tip 63. Stabilizing valve assembly 52 includes a tube 86 defining an opening 88 therethrough and a semi-spherical valve seat 90 disposed at an upper end 92 of tube 86. A ball stop 94 is positioned against valve seat 90 and biased against valve seat 90 via a spring 96 that extends from a lower end 98 of tube 86 to ball stop 94. In the exemplary embodiment, ball stop 94 is sized and oriented to create a sealed surface 100 between ball stop 94 and valve seat 90 such that no fluid 12 may flow therethrough when ball stop 94 is biased against valve seat 90.

During operation, release valve assembly 66 facilitates creating a sealed channel and prevents fluid, and any gaseous fumes associated therewith contained within dispenser 10, from passing out of dispenser 10 during periods of non-use when dispenser 10 is positioned in any orientation, such as a vertical up-right orientation, a horizontal orientation or an inverted orientation. As a pressure is exerted against dispenser 10, ball stop 74 from release valve assembly 66 overcomes the biasing force exerted thereon by spring 76, allowing fluid 12 to flow within stem 65 in the direction of arrow 102 (shown in FIG. 2), and exit dispenser 10 at tip 63. Subsequently, when pressure is released from dispenser 10, pressure is reduced internally within dispenser 10. This action causes the external pressure to overcome the internal pressure, causing ball stop 74 within release valve assembly 66 to move against valve seat 70 closing off further dispensing of fluid 12 through stem 65. Because ambient pressure is higher following the release of pressure being exerted upon dispenser 10 than the internal pressure of dispenser 10, air moves in the direction of arrow 104 through opening 88 which overcomes the biasing force exerted thereon by spring 96, and allows stabilizing valve assembly 52 to open and thereby facilitates channeling a quantity of air through the stabilizing valve assembly 52 and into dispenser 10, which returns dispenser 10 to a non-use configuration (e.g., as is shown in FIG. 1).

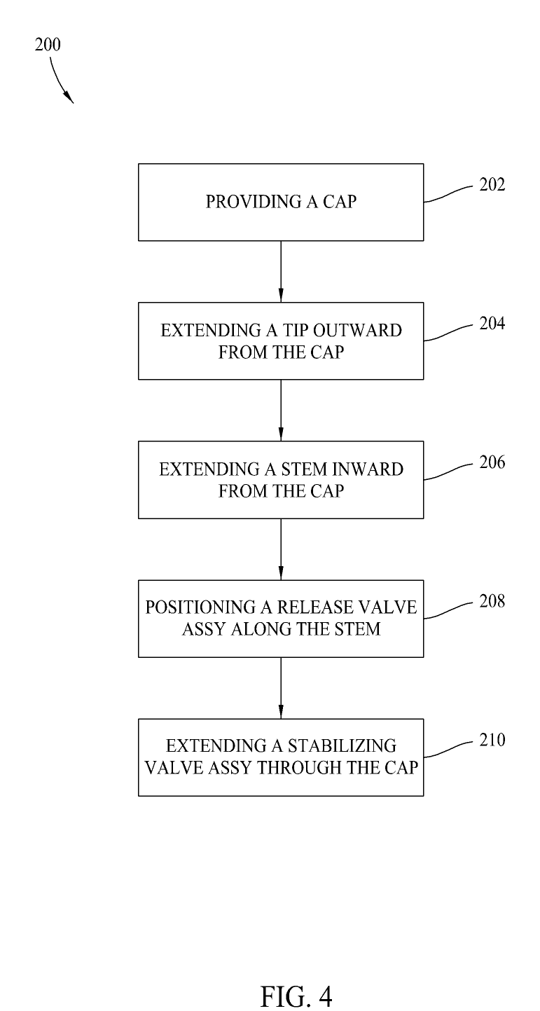

FIG. 4 is a flowchart of an exemplary method 200 of assembling the self-sealing cap assembly 50 shown in FIG. 2. In the exemplary embodiment, method 200 includes providing 202 a cap for a fluid dispenser that includes an inner surface and an outer surface, and extending 204 a tip from the outer surface of the cap, wherein the tip includes an aperture therethrough that is configured to dispense a fluid stored within the dispenser. In the exemplary embodiment, the inner surface of cap is fabricated with a plurality of threads that are sized and oriented to threadably couple to a dispenser. Alternatively, cap may be coupled to dispenser using any coupling means such as, but not limited to, friction fitting, a tab and groove combination, and/or with any coupling configuration that enables the dispenser to function as described herein.

Method 200 includes extending 206 a stem inward from the inner surface of the cap such that the stem is axially aligned and coupled in flow communication with the aperture of the tip. Additionally, method includes positioning 208 a release valve assembly at a point along a length of the stem, wherein the release valve assembly facilitates creating a sealed surface therein and substantially preventing the fluid from passing out of the dispenser when the dispenser is positioned in any orientation, including a vertical up-right orientation, a horizontal orientation or an inverted orientation. Sealed surface also prevents a flow of gas associated with the liquid from escaping the dispenser. A biasing spring is disposed within the release value assembly, wherein the biasing spring is operable to urge a ball stop against a valve seat, such that the sealed surface is defined between said ball stop and said valve seat.

Method 200 includes extending 210 a stabilizing valve assembly from the inner surface of the cap to the outer surface of the cap. Furthermore, a tube is fabricated that includes a semi-spherical valve seat disposed at an upper end of tube. A ball stop is positioned against valve seat and biased against valve seat via a spring that extends from a lower end of tube to the ball stop. In the exemplary embodiment, ball stop is sized and oriented to create a sealed surface between ball stop and valve seat such that no fluid may flow therethrough when ball stop is biased against valve seat.

Exemplary embodiments of self-sealing dispenser cap assemblies are described in detail above. The above-described dispenser cap assemblies facilitate providing a sealed chemical dispenser that would normally emit chemical vapors into the surrounding atmosphere when not in use. More specifically, the dispenser cap assemblies described herein ensure safe environmental conditions in areas where chemicals are stored and facilitates maintaining an area surround the dispenser that is free from harmful gases that may be emitted from the stored chemicals by enabling the dispenser to use atmospheric pressure to seal the dispenser when not in use. Also, the systems described herein will prevent leaking of should chemicals such the dispenser become overturned.

Although the foregoing description contains many specifics, these should not be construed as limiting the scope of the present invention, but merely as providing illustrations of some of the presently preferred embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

Although the assemblies and methods described herein are described in the context of using a self-sealing cap with flexible chemical dispensers, it is understood that the apparatus and methods are not limited to chemical storage devices. Likewise, the system components illustrated are not limited to the specific embodiments described herein, but rather, system components can be utilized independently and separately from other components described herein.

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

This written description uses examples to disclose various embodiments, including the best mode, and also to enable any person skilled in the art to practice the embodiments contained herein, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A dispenser for storing a quantity of fluid therein, said dispenser comprising:
a self-sealing dispenser cap assembly comprising;
a cap comprising an inner surface and an outer surface;
a tip extending from said outer surface of said cap, said tip comprising an aperture therethrough operable to dispense the fluid stored within said dispenser;
a stem extending inward from said inner surface of said cap, said stem axially aligned and coupled in flow communication with said aperture of said tip, said stem comprising a release valve assembly positioned along a length of said stem, wherein said release valve assembly facilitates creating a sealed surface therein and substantially preventing the liquid from passing out of said dispenser, wherein applying a force to said dispenser facilitates channeling fluid through said release valve assembly; and
a stabilizing valve assembly extending from said inner surface of said cap to said outer surface of said cap, wherein removing the force from said dispenser facilitates channeling a quantity of air through said stabilizing valve assembly and into said dispenser; and
a body portion operable to contain and store the fluid therein; and
a mouth portion extending from said body portion, said mouth portion configured to receive said dispenser cap assembly thereon.

2. A dispenser in accordance with claim 1, wherein said cap and said mouth portion are coupled together using one of a friction fit and a threaded interface.

3. A dispenser in accordance with claim 1, wherein said sealed surface facilitates substantially preventing the flow of a gas associated with said liquid from said dispenser.

4. A dispenser in accordance with claim 1, wherein said release valve assembly comprises:
a biasing spring;
a ball stop; and
a valve seat, said biasing spring operable to urge said ball stop against said valve seat, wherein said sealed surface is defined between said ball stop and said valve seat.

5. A dispenser in accordance with claim 1, wherein said stabilizing valve assembly comprises:
a biasing spring;
a ball stop; and
a valve seat, said biasing spring operable to urge said ball stop against said valve seat.

6. A dispenser in accordance with claim 1, wherein said dispenser further comprises a flexible outer wall.

7. A dispenser in accordance with claim 1, wherein said self-sealing dispenser cap prevents the flow of the fluid or a gas associated therewith from said dispenser when said dispenser is in one of a vertical up-right orientation, a horizontal orientation or an inverted orientation.

8. A dispenser in accordance with claim 1, wherein said release valve assembly is positioned adjacent said cap along the length of said stem.

9. A dispenser in accordance with claim 1, wherein each of said release valve assembly and said stabilizing valve assembly comprise a one-way ball value.

10. A self-sealing dispenser cap assembly comprising:
a cap comprising an inner surface and an outer surface;
a tip extending from said outer surface of said cap, said tip comprising an aperture therethrough operable to dispense the fluid therethrough;
a stem extending inward from said inner surface of said cap, said stem axially aligned and coupled in flow communication with said aperture of said tip, said stem comprising a release valve assembly positioned along a length of said stem, wherein said release valve assembly facilitates creating a sealed surface therein and substantially preventing the liquid from passing out of said dispenser, wherein applying a force to said dispenser facilitates channeling fluid through said release valve assembly; and
a stabilizing valve assembly extending from said inner surface of said cap to said outer surface of said cap, wherein removing the force from said dispenser facilitates channeling a quantity of air through said stabilizing valve assembly and into said dispenser.

11. A dispenser cap in accordance with claim 10, wherein said sealed surface facilitates substantially preventing a flow of a gas associated with said liquid from said dispenser.

12. A dispenser cap in accordance with claim 10, wherein said release valve assembly comprises:
a biasing spring;
a ball stop; and
a valve seat, said biasing spring operable to urge said ball stop against said valve seat, wherein said sealed surface is defined between said ball stop and said valve seat.

13. A dispenser cap in accordance with claim 10, wherein said stabilizing valve assembly comprises:
a biasing spring;
a ball stop; and
a valve seat, said biasing spring operable to urge said ball stop against said valve seat.

14. A method for assembling a self-sealing dispenser cap comprising:
providing a cap comprising an inner surface and an outer surface;
extending a tip from the outer surface of the cap, the tip comprising an aperture therethrough operable to dispense a liquid stored within the dispenser;
extending a stem inward from the inner surface of the cap such that the stem is axially aligned and coupled in flow communication with the aperture of the tip;
positioning a release valve assembly at a point along a length of the stem, wherein the release valve assembly facilitates creating a sealed surface therein and substantially preventing the fluid from passing out of the dispenser; and
extending a stabilizing valve assembly from the inner surface of the cap to the outer surface of the cap, wherein removing the force from the dispenser facilitates channeling a quantity of air through said stabilizing valve assembly and into said dispenser.

15. A method in accordance with claim 14, wherein positioning a release valve assembly at a point along a length of the stem further comprises preventing a flow of gas associated with the liquid from escaping the dispenser.

16. A method in accordance with claim 15, wherein positioning a release valve assembly at a point along a length of the stem further comprises preventing the flow of the fluid or a gas associated therewith from the dispenser when the dispenser is in one of a vertical up-right orientation, a horizontal orientation or an inverted orientation.

17. A method in accordance with claim 14, wherein positioning a release valve assembly at a point along a length of the stem further comprises mounting a biasing spring within the release value assembly, where the biasing spring is operable to urge a ball stop against a valve seat and said the sealed surface is defined between said ball stop and said valve seat.

18. A method in accordance with claim 14, wherein extending a stabilizing valve assembly from the inner surface of the cap to the outer surface of the cap further comprises mounting a biasing spring within the stabilizing value assembly.

19. A method in accordance with claim 14, wherein positioning a release valve assembly at a point along a length of the stem further comprises positioning the release valve assembly adjacent to the cap along the length of the stem.

20. A method in accordance with claim 14 wherein providing a cap further comprises configuring the inner surface of the cap to threadably couple to a dispenser.
